(19) United States
(12) Patent Application Publication
(10) Pub. No.: US 2025/0176591 A1
(43) Pub. Date: Jun. 5, 2025

(54) REDUCING COMPOSITIONS AND METHODS FOR PREVENTING MICROBIAL CONTAMINATION AND CONTROLLING OXIDATIVE PROCESSES

(71) Applicant: Altered Labs LLC, Miramar, FL (US)

(72) Inventor: Dario ECHEVERRY CAMPOS, Miramar, FL (US)

(21) Appl. No.: 18/843,697

(22) PCT Filed: Mar. 3, 2023
(86) PCT No.: PCT/US2023/014480

§ 371 Date: Sep. 3, 2024

Related U.S. Application Data
(60) Provisional application No. 63/316,649, filed on Mar. 4, 2022.

(51) Int. Cl. A23K 30/00; A23B 2/788; A23K 20/28; A23K 50/40

(52) U.S. Cl. CPC A23K 30/00; A23B 2/788; A23K 20/28; A23K 50/40

(57) ABSTRACT

A method of preventing microbial contamination in a food product or composition is disclosed. Also disclosed are preservative compositions prepared using reducing gas which are useful for extending shelf-life and/or preventing bacterial contamination of food products and compositions. Also disclosed are food products and compositions prepared using the disclosed preservative compositions. Methods of preparing preservative compositions and food products are also described.

### CROSS-REFERENCE TO RELATED APPLICATIONS

The present application claims the benefit of U.S. Provisional Patent Application No. 63/316,649 filed Mar. 4, 2022, the entire contents of which are hereby incorporated by reference for all purposes.

### BACKGROUND OF THE INVENTION

### Technical Field

The present invention is directed to compositions, methods of use thereof, to prevent and/or inhibit bacterial growth in food products and control oxidative processes.

In certain embodiments, the present invention is directed to compositions for use as preservatives in food products.

The present invention is also directed to compositions and methods for preserving a food product, as well as compositions and methods for extending the shelf-life of a food product.

The present invention is also directed to compositions and methods for changing the high oxidation potential present in most foods, which is due to the presence of preservatives added to prevent spoiling. These preservatives make the treated food very acidic, very oxidant and with a positive oxidation reduction potential (ORP) (measured in millivolts). The present invention changes these conditions to being alkaline, antioxidant (i.e., reducing agent) and having a negative ORP; making the treated food good for health in animals and human beings.

In some embodiments, the present invention is directed to compositions for use in animal food products, such as pet or livestock food products, as well as methods of using the same.

Additionally, the present inventor has found that compositions and methods described herein confer antimicrobial activity to a food product. Said compositions and methods are useful for preventing bacterial growth and thereby preventing oxidation/spoliation of food products and contamination of surfaces, containers, and/or other food products that may come into contact with a spoiled or contaminated food product.

In the case of pet foods, for example, contamination can occur during the manufacturing process, storage, or even preparation. Freezing and drying processes (e.g., lyophilization) may reduce, but not eradicate, bacterial contamination in raw pet food. There is thus a need for quality control in the manufacturing process and pet owners must take care to exercise additional personal hygiene practices to reduce health risks associated with handling raw pet food, in addition to the health risks posed to pets consuming raw pet foods. Even in the case of non-raw pet foods, contamination may be introduced during manufacturing and/or preparation processes.

There is thus an ongoing need for new food-safe preservatives and additives which prevent or inhibit microbial (e.g., bacterial) growth.

### SUMMARY

The present disclosure provides for a method for preparing a preservative food composition, the method comprising (i) infusing an aqueous solution with a reducing gas and/or a highly reducing, negative ORP substance (“a HNORP”) such as but not limited to a reformed metasilicate, wherein the infusing involves mixing under turbulent conditions, to produce a preservative composition, and (ii) admixing the preservative composition with a food composition to produce a preservative food composition, wherein the reducing gas and/or the metasilicate reacts with the aqueous solution to produce a reducing liquid having the oxidation reduction potential (ORP) value of about −100 mV or more negative.

The present disclosure further provides for a method for preparing a preservative food composition, the method comprising infusing a food composition with a reducing gas and a HNORP, wherein the infusing involves mixing under turbulent conditions, to produce a preservative food composition, wherein the reducing gas and/or the metasilicate reacts with the aqueous solution to produce a reducing liquid having the oxidation reduction potential (ORP) value of about −100 mV or more negative.

The present disclosure further provides for a preservative food composition prepared by a method comprising (i) infusing an aqueous solution with a reducing gas and a HNORP, wherein the infusing involves mixing under turbulent conditions, to produce a preservative composition, and (ii) admixing the preservative composition with a food composition to produce a preservative food composition, wherein the reducing gas and/or the metasilicate reacts with the aqueous solution to produce a reducing liquid having the oxidation reduction potential (ORP) value of about −100 mV or more negative.

The present disclosure further provides for a preservative food composition prepared by a method comprising infusing a food composition with a reducing gas and a HNORP, wherein the infusing involves mixing under turbulent conditions, to produce a preservative food composition, wherein the reducing gas and/or the metasilicate reacts with the aqueous solution to produce a reducing liquid having the oxidation reduction potential (ORP) value of about −100 mV or more negative.

Other aspects of the present invention will be made apparent by the following detailed description. Additional aspects of the present invention will be readily apparent to a person of ordinary skill in the art in view of the following disclosure.

### DETAILED DESCRIPTION

Set forth below with reference to the accompanying drawings is a detailed description of a method for preparing compositions described herein useful for preserving or extending the shelf-life of a food product, such as a pet food product, a method for preserving a food product comprising combining a preservative composition described herein with a food product, all representing examples of the inventions disclosed here.

The detailed description set forth below is intended as a description of various configurations of the subject technology and is not intended to represent the only configurations in which the subject technology may be practiced.

The appended drawings are incorporated herein and constitute a part of the detailed description.

The detailed description includes specific details for the purpose of providing a thorough understanding of the subject technology. However, it will be apparent to those skilled in the art that the subject technology may be practiced without these specific details.

It is understood that various configurations of the subject technology will become readily apparent to those skilled in the art from the disclosure, wherein various configurations of the subject technology are shown and described by way of illustration. As will be realized, the subject technology is capable of other and different configurations and its several details are capable of modification in various other respects, all without departing from the scope of the subject technology. Accordingly, the summary, drawings and detailed description are to be regarded as illustrative in nature and not as restrictive.

Unless otherwise defined, all technical and scientific terms used herein have the same meaning as commonly understood by a person having ordinary skill in the art to which the present invention belongs. While methods and materials similar or equivalent to those described herein can be used to practice the invention, suitable methods and materials are described herein. All publications, patent applications, patents, and/or other references mentioned herein are incorporated by reference in their entireties. In the event that any of the publications, patent applications, patents and/or other references mentioned and incorporated herein contradict the present disclosure, the present disclosure including the definitions is authoritative. Additionally, the materials, methods, and examples are illustrative only and are not intended to be limiting.

“Hydrogas™” is an electrolytic process for the production of a non-toxic, non-corrosive, stable, reducing gas that can be infused into liquids, including water and aqueous solutions, including liquids intended for consumption by any animal or administration (e.g., intravenous) to any animal, or for cultivation of any plant (e.g., a plant used to prepare a food product such as an animal food product), and also including any liquids used to prepare food products for mammalian consumption by an animal. The electrolytic process reduces the liquid oxidation reduction potential and increases dissolved free electrons, as well as Hydroxide (OH) and free H₂ content.

The exemplary methods disclosed herein are based on the combination of a highly reducing, negatively charged gas such as “Hydrogas™”, and a highly reducing, high alkaline liquid (e.g., a highly reducing, negative ORP or “HRNORP”) or powder, such as reformed sodium metasilicate (RLS). The RLS according to the present invention may be formed with any high alkaline, non-caustic, food-grade or food-safe liquid (e.g., any HRNORP liquid). The highly reducing gas may also be any highly reducing, negatively charged gas, including but not limited to such gases as HHO, BROWNS Gas, Tylar Gas, Knell Gas, etc.

In an aspect of the present invention, a liquid infused via Hydrogas™ is used as a preservative composition or is used to prepare a preservative and antioxidant composition, which may be incorporated into or otherwise used to prepare a food product or food composition.

Additional ingredients or components may also be utilized in exemplary embodiments of the inventive compositions and methods, which combine with products and compositions described herein. Said additional ingredients or components include but are not limited to flavorants and palatability enhancers (i.e., palatants), sweetening agents (sweeteners), meat-based food content, plant-based food content, or other food-safe or food-grade ingredients or components.

Amounts, concentrations, ratios disclosed herein are exemplary only, and a person of ordinary skill in the art may use other amounts, concentrations or ratios in light of the following disclosure.

The processes and protocols and other methods described herein are disclosed for exemplary, illustrative purposes only. The processes, protocols and methods may vary in other exemplary uses of the methods.

The articles “a” and “an” are used herein to refer to one or to more than one (i.e. to at least one) of the grammatical object of the article. By way of example, an element means one element or more than one element.

As used herein in reference to a value, the term “about” refers to a value that is similar, in context to the referenced value. In general, those skilled in the art, familiar with the context, will appreciate the relevant degree of variance encompassed by “about” in that context. For example, in some embodiments, the term “about” can encompass a range of values that within 25%, 20%, 19%, 18%, 17%, 16%, 15%, 14%, 13%, 12%. 11%, 10%, 9%, 8%, 7%, 6%, 5%, 4%, 3%, 2%, 1%, or less of the referred value. The details of one or more embodiments of the invention are set forth in the accompanying drawings and the description below. Further features, objects and advantages of the invention will become apparent from the description and the drawings as well as from the claims.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Whenever a numerical range of degree or measurement with a lower limit and an upper limit is disclosed, any number and any range falling within the range is also intended to be specifically disclosed. For example, every range of values (in the form “from a to b,” or “from about a to about b.” or “from about a to b.” “from approximately a to b,” and any similar expressions, where “a” and “b” represent numerical values of degree or measurement) is to be understood to set forth every number and range encompassed within the broader range of values.

All numerical ranges defined herein are inclusive of endpoints and all values thereinbetween, unless otherwise specifically stated. For example, “at a concentration of a-b” means “at a concentration of at least a and at most b.”

As used herein, the terms “subject” and “recipient” refer to human and non-human animals, including veterinary subjects. The term “non-human animal” includes all vertebrates, e.g., mammals and non-mammals, such as non-human primates, mice, rabbits, sheep, dog, cat, horse, cow, chickens, amphibians, and reptiles. In a preferred embodiment, the subject is a human.

As used herein, the term “administration” refers to the administration of a composition to a subject/recipient or system, for example to feed a subject or recipient a food product or composition.

In certain embodiments, the administration achieves feeding a food product or composition to a subject or recipient.

In certain other exemplary embodiments, the food product or composition may optionally comprise one or more therapeutically effective amounts of a therapeutic active agent, such as a medicament, e.g., a pharmaceutical or veterinary medicine, a vitamin, a probiotic, or the like.

As used herein, the term “agent” refers to a substance, entity or complex, combination, mixture or system, or phenomenon (e.g., heat, electric current or field, magnetic force or field, etc.).

As used herein, “associated with” denotes a relationship between two events, entities and/or phenomena. Two events, entities and/or phenomena are “associated” with one another, as that term is used herein, if the presence, level and/or form of one is correlated with that of the other.

Those skilled in the art will appreciate that the term “composition”, as used herein, can be used to refer to a discrete physical entity that comprises one or more specified components. In general, unless otherwise specified, a composition can be of any form, e.g., gas, gel, liquid, solid, etc. In certain embodiments, the composition is a food composition or food product, e.g. a pet food.

As used herein, the terms “food-safe” or “food-acceptable” or “food-grade” as applied to the inventive composition or any other additive or excipient used to formulate a composition disclosed herein means that the composition, additive or other excipient is safe for consumption by a subject.

In certain embodiments, the subject is a mammal. In certain other embodiments, the subject is a human.

In yet other embodiments, the subject is a companion animal (i.e., a pet), including but not limited to a dog, cat, bird (e.g., parrot, cockatoo, or other bird), fish, rodent (e.g., mouse, rat, rabbit, guinea pig, hamster, gerbil, etc.), horse, pig, cow, sheep, goat or other mammal.

In certain embodiments, the subject is an animal raised for human consumption (i.e., livestock), including but not limited to cows, pigs, goats, sheep, bison, poultry (e.g., fowl and waterfowl, such as chickens, ducks, geese, pheasants, quails, and the like).

In certain embodiments, the subject is an amphibian, such as a frog or salamander, or a reptile, such as a snake, lizard (e.g., iguana), etc.

In an aspect, a food-safe composition or ingredient (additive or excipient) is compatible with the other ingredients contained in a food composition and is not deleterious to the recipient thereof. Similarly, as used herein, the terms “food-safe” or “food-acceptable” or “food-grade” means that a composition or ingredient disclosed herein for use in the inventive composition is compatible with the other ingredients of the food composition or formulation and not injurious to the recipient.

Some examples of additional materials which may be included: sugars, such as lactose, glucose and sucrose; starches, such as corn starch and potato starch; cellulose, and its derivatives, such as sodium carboxymethyl cellulose, ethyl cellulose and cellulose acetate; powdered tragacanth; malt; gelatin; talc; excipients, such as cocoa butter and suppository waxes; oils, such as peanut oil, cottonseed oil, safflower oil, sesame oil, olive oil, corn oil and soybean oil; glycols, such as propylene glycol; polyols, such as glycerin, sorbitol, mannitol and polyethylene glycol; esters, such as ethyl oleate and ethyl laurate; agar; buffering agents, such as magnesium hydroxide and aluminum hydroxide; alginic acid; pyrogen-free water; isotonic saline; Ringer's solution; ethyl alcohol; pH buffered solutions; polyesters, polycarbonates and/or polyanhydrides; and other non-toxic compatible substances employed in pharmaceutical formulations.

As used herein when used in connection with the occurrence of a disease, disorder, and/or condition, “prevent” (and grammatical variations thereof) refers to reducing the risk of developing the disease, disorder and/or condition and/or to delaying onset of one or more characteristics or symptoms of the disease, disorder or condition. Prevention can be considered complete when onset of a disease, disorder or condition has been delayed for a predefined period of time.

An individual who is “susceptible to” a disease, disorder, or condition is at risk for developing the disease, disorder, or condition. In some embodiments, an individual who is susceptible to a disease, disorder, or condition does not display any symptoms of the disease, disorder, or condition. In some embodiments, an individual who is susceptible to a disease, disorder, or condition has not been diagnosed with the disease, disorder, and/or condition. In some embodiments, an individual who is susceptible to a disease, disorder, or condition is an individual who has been exposed to conditions associated with development of the disease, disorder, or condition. In some embodiments, a risk of developing a disease, disorder, and/or condition is a population-based risk (e.g., family members of individuals suffering from the disease, disorder, or condition).

As used herein, the term “therapeutically effective amount” refers to an amount that produces the desired effect for which it is administered. In some embodiments, the term refers to an amount that is sufficient, when administered to a population suffering from or susceptible to a disease, disorder, and/or condition in accordance with a therapeutic dosing regimen, to treat the disease, disorder, and/or condition. In some embodiments, a therapeutically effective amount is one that reduces the incidence and/or severity of, and/or delays onset of, one or more symptoms of the disease, disorder, and/or condition. Those of ordinary skill in the art will appreciate that the term “therapeutically effective amount” does not in fact require successful treatment be achieved in a particular individual. Rather, a therapeutically effective amount can be that amount that provides a particular desired pharmacological response in a significant number of subjects when administered to patients in need of such treatment. In some embodiments, reference to a therapeutically effective amount can be a reference to an amount as measured in one or more specific tissues (e.g., a tissue affected by the disease, disorder or condition) or fluids (e.g., blood, saliva, serum, sweat, tears, urine, etc.). Those of ordinary skill in the art will appreciate that, in some embodiments, a therapeutically effective amount of a particular agent or therapy can be formulated and/or administered in a single dose. In some embodiments, a therapeutically effective agent can be formulated and/or administered in a plurality of doses, for example, as part of a dosing regimen.

In certain embodiments, a food-safe or food-grade composition containing an inventive composition or additive described herein may be used as part of a feeding schedule or regimen.

In certain embodiments, the feeding regimen may be a method of treating a condition or disease comprising administering an active ingredient in a therapeutically effective amount or dose to a subject or recipient in combination with a food product described herein.

As used herein, the terms “treating” or “treatment” (and grammatical variations thereof) refer to administration of a therapy that partially or completely alleviates, ameliorates, relieves, inhibits, delays onset of, reduces severity of, and/or reduces incidence of one or more symptoms, features, and/or causes of a particular disease, disorder, and/or condition, or is administered for the purpose of achieving any such result. In some embodiments, such treatment can be of a subject who does not exhibit signs of the relevant disease, disorder and/or condition and/or of a subject who exhibits only early signs of the disease, disorder, and/or condition. Alternatively or additionally, such treatment can be of a subject who exhibits one or more established signs of the relevant disease, disorder and/or condition. In some embodiments, treatment can be of a subject who has been diagnosed as suffering from the relevant disease, disorder, and/or condition. In some embodiments, treatment can be of a subject known to have one or more susceptibility factors that are statistically correlated with increased risk of development of the relevant disease, disorder, and/or condition. In various examples, treatment is of a cancer. Tumor: As used herein, the term “tumor” refers to an abnormal growth of cells or tissue. In some embodiments, a tumor can comprise cells that are precancerous (e.g., benign), malignant, pre-metastatic, metastatic, and/or non-metastatic. In some embodiments, a tumor is associated with, or is a manifestation of, a cancer. In some embodiments, a tumor can be a disperse tumor or a liquid tumor. In some embodiments, a tumor can be a solid tumor.

As used herein, “Hydrogas™” refers to a reducing gas prepared according to the electrolytic process described in the present disclosure.

As used herein. “restructuring” refers to a process for transforming a liquid into a reducing liquid. As used herein, “restructured liquid” or “reducing liquid” refers to a liquid which has undergone restructuring. A reducing liquid is used to prepare a preservative composition described herein, which is subsequently incorporated into or otherwise used to prepare a food composition or food product having improved antimicrobial (e.g., antibacterial) properties.

As used herein, the terms “infuse” or “infusion” or “infusing” or any variation thereof encompasses any other suitable method of mixing reducing gas or silicate with liquid, such as injecting, administering, or applying. In some embodiments, a process is provided for preparing a stable, non-toxic, non-corrosive reducing liquid by infusing a gas produced by the electrolytic process described herein into a “source liquid” to be treated using described processes. The source liquid can be any suitable liquid that can stably incorporate an infused reducing gas. Examples of suitable source liquids include, but are not limited to, organic solvents, nonpolar oils, mineral oils, essential oils, colloidal suspensions, colloidal solutions, leachates from landfills, polychlorinated byphenols (PCBs), and aqueous compositions. In preferred embodiments, the source liquid for infusion is water to be used to prepare cell culture media. Sources of water include for example, distilled water, deionized water, tap water, potable water, potable beverages, nonpotable water, agricultural water, irrigation water, salt water, brackish water, fracking waters, water having aqueous heavy metals dissolved therein, industrial water, recycled water, fresh water, water from a natural source, or reverse osmosis water. Potable water is understood to be water safe for human or animal consumption; non-potable water is not safe for human or animal consumption, but can be used in other applications. Fresh water is understood to be water from a natural source that is not salt water. Salt water may be from a natural source such a sea or ocean, it also includes man-made salt water. Industrial water is water that is a used in industrial applications such as manufacturing processes, washing of containers, machines, etc. Industrial water may be tap water, well water, etc that is typically non-potable water.

As used herein, the term “substantially free” refers to quantities of less than about 1%, preferably less than about 0.1% for the indicated matter.

In an aspect, the present invention involves restructuring a liquid in, such as water or an aqueous solution, to a reducing liquid to be subsequently used to prepare a therapeutically effective composition. The liquid restructuring is performed using a non-toxic and stable reducing gas to decrease the amount of undesirable oxidants (e.g., ROS) present in the liquid.

The process for preparing a reducing gas may comprise preparing an activator, wherein the activator comprises water, potassium hydrate, magnesium sulfate, sodium oxidanide, and an alkaline metal silicate; introducing the activator into a reaction chamber of a reactor, wherein the reactor is configured to produce an electrolytic reaction; adding water to the reaction chamber to provide a water-activator mixture; and applying a direct current in the water-activator mixture to produce the reducing gas. It is generally desirable that the pressure in the reaction chamber is reduced to increase the rate of production of the reducing gas. In a preferred embodiment, the reducing pressure in the reaction chamber is maintained at about 0.5 bar. The reactor chamber typically comprises a wet electrolytic cell to propel the electrolytic reduction process as described herein. Additional information may be found in WO2019/232387, the relevant disclosures of which are incorporated by references for the subject matter and purpose referenced herein.

The activator may be prepared using any suitable equipment for conducting chemical reactions involving the activator reagents. Typically, the activator is prepared by combining the activator components in a balanced stoichiometric amounts from the oxidation-reduction equation. In some embodiments, the activator comprises potassium hydrate, magnesium sulfate, sodium oxidanide, and an alkaline metal silicate in a predetermined stoichiometric ratio. The activator can comprise about 40 wt % to about 59 wt % potassium hydrate; about 0.1 wt % to about 5 wt % magnesium sulfate; about 40 wt % to about 59 wt % sodium oxidanide; and about 0.1% to about 5 wt % alkaline metal silicate. In other embodiments, the activator can comprise about 45 wt % to about 55 wt % potassium hydrate; about 0.2 wt % to about 3 wt % magnesium sulfate; about 45 wt % to about 55 wt % sodium oxidanide; and about 0.2% to about 3 wt % alkaline metal silicate. In other embodiments, the activator can comprise about 47 wt % to about 53 wt % potassium hydrate; about 0.2 wt % to about 1.5 wt % magnesium sulfate; about 47 wt % to about 53 wt % sodium oxidanide; and about 0.2% to about 1.5 wt % alkaline metal silicate. In other embodiments, the activator can comprise about 48 wt % to about 51 wt % potassium hydrate; about 0.3 wt % to about 0.8 wt % magnesium sulfate; about 48 wt % to about 51 wt % sodium oxidanide; and about 0.3% to about 0.8 wt % alkaline metal silicate. Potassium hydrate, magnesium sulfate, and sodium oxidanide are commercially available. In other embodiments, the activator is a liquid solution comprising potassium hydrate, magnesium sulfate, sodium oxidanide, and an alkaline metal silicate in any of the stoichiometric amounts described herein. The liquid solution can have an activator concentration of about 0.1 to about 20 g/l, about 0.1 to about 15 g/l, about 0.1 to about 10 g/l, about 0.1 to about 5 g/l, about 0.5 to about 4 g/l, about 0.5 to about 3 g/l, about 1 to about 3 g/l, or about 1.5 to about 2.5 g/l.

The activator can be prepared by any suitable method. For example, the potassium hydrate, sodium oxidanide, alkaline cationic silicate, and magnesium sulfate can be measured out in any of the weight ratios described herein, and subsequently combined to form a single activator mixture. This activator mixture can then be dissolved into water at a predetermined concentration as described hereinabove. Alternatively, a quantity of water can be provided, and the potassium hydrate, sodium oxidanide, alkaline cationic silicate, and magnesium sulfate can be added to the quantity of water in sequence, simultaneously, or combined pairs. In some embodiments, the magnesium sulfate and the alkaline cationic silicate are first mixed into the quantity of water, and the potassium hydrate and sodium oxidanide are subsequently mixed into the quantity of water. Preparation of the activator can be carried out external to a reactor and subsequently added in. Alternatively, the activator can be prepared in a reaction chamber of a reactor. Preferably, the alkaline cationic silicate is a metasilicate such as an alkaline sodium silicate complex (SSC) or reformed liquid silica (RLS). The metasilicate can be used in the preparation of an activator, and may optionally be added in greater quantities with or without the reducing gas into the source liquid. These complexes are described, for example, in US20110059189A1, which is incorporated herein by reference. Mass spectroscopic (MS) and nuclear magnetic resonance (NMR) analysis generated a putative empirical formula of the compound or complex to be Na8.2Si4.4H9.7017.6. The formula suggests that alkaline sodium silicate complex (SSC) is not a single compound but a mixture of two different compounds that are in equilibrium with each other. Specifically, the SSC is a mixture of trimeric sodium silicate (Na₂Si0₃)₃, Na Na⁴Na⁴:

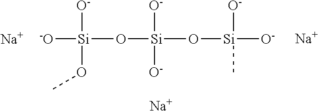

and Sodium Silicate Pentahydrate (Na₂Si0₃)5H₂O.

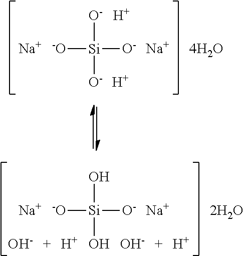

Sodium silicate pentahydrate (Na₂Si0₃) 5H₂O typically exists in equilibrium as two structural forms, with one form containing one ionized water molecule and the other form containing 3 ionized water molecules. To produce SSC, silicon metal (any grade) is loaded into a reactor. Sodium oxidanide is added along with water. An exothermic reaction occurs. The reaction is allowed to proceed for 4-6 hours, after which the product is collected in a cooling tank. The product is cooled and the obtained liquid product is packaged.

The silicon-based alkaline composition (empirical formula of Na8.2Si4.4H9.7017.6) can have a specific density in the range of 1.24 to 1.26 kg/m³, for example, 1.25±0.1 kg/m³. The composition can also have a pH in the range of 13.8 to 14.0, for example, 13.9±0.1. In some embodiments, the SSC can be dried via any suitable method prior to use in any of the processes described herein. Suitable drying methods include, but are not limited to, mild heating, storage in a desiccator, vacuum drying.

SSC physiochemical properties and potential therapeutic applications have been previously studied. In one study, SSC was found to exhibit antimicrobial properties for gram positive, gram negative, and drug resistant strains as described, for example, in Vatten et al., Res. J. Microbiol. 2012 Mar. 1; 7 (3): 191-8. Sodium silicate is also generally recognized as safe for human consumption by the US FDA pursuant to 21 C.F.R. § 182.90. US20140087003A1 describes a method using an alkaline sodium silicate composition to inhibit the toxic effects of venom and treat venomous bites and stings. US20060275505A1 describes a composition for increasing alkalinity in the body containing water, a source of alkalinity; particularly an alkaline silicon solution. US20110059189A1 describes a modified sodium silicate composition, and methods of treating cancer and viral infections utilizing the modified sodium silicate composition (Na_{8.2}Si_{4.4}H_{9.7}0_{17.6}), also described in Townsend et al., Int. J. Appl. Res. Nat. Prod. 2010; 3:19-28 (AVAH silicates were also effective in inhibiting several important physiological events important in survival and development of virulence in viral and microbial pathogens). However, the SSC referenced in those publications did not involve a reducing gas, the combination of which is a subject under this description, along with other beneficial uses of this technology.

The electrolytic process is generally carried out in a reactor. In an exemplary process, the activator is either prepared within a reaction chamber of the reactor or externally prepared and subsequently added to the reaction chamber. Additional water can be combined with the activator in the reaction chamber in any suitable quantity, including up to the fill capacity of the reaction chamber.

The reactor can be any suitable apparatus for carrying out an electrolytic reaction. In some embodiments, the reactor comprises a wet electrolytic cell. In an electrolytic cell, an electric current is passed from an electronic conductor through a chemical substrate such as an ionic solution contained in one or more cells (i.e., reaction chamber), back into a second electronic conductor. The circuit is closed outside (external circuit) of the cell through various electronic conductors. This typically includes a power supply and a current measuring device. The junctions between the electronic and ionic conductors are called electrodes, namely cathodes and anodes. In the electrolysis reaction, a direct current is passed through the solution contained in the reaction chamber, producing chemical reactions at the electrodes. In a standard electrolysis of pure water (i.e., without activator present), a reduction half reaction occurs at the cathode in which electrons from the cathode are transferred to hydrogen cations to form H₂ gas as illustrated by the chemical equation: 2H+(aq)+2e H₂(g). At the anode, an oxidation half reaction occurs in which electrons are transferred from water molecules to the anode to form 0₂ gas as illustrated by the chemical equation: 2H₂0 (1) 02 (g)+4H⁺(aq)+4e⁻. These half reactions can be balanced with the addition of base.

A direct current (DC) electrical supply is coupled to the reactor and provides the energy necessary to drive the electrolytic process. Electric current is carried by electrons in the external circuit. Electrodes of metal, graphite and semiconductor material are widely used. Choice of suitable electrode depends on chemical reactivity between the electrode and electrolyte and manufacturing cost. A DC electrical power source is connected to two electrodes, or two plates (typically made from some inert metal such as platinum, stainless steel 360 or iridium) which are placed in the water. In some embodiments, the DC delivered to the electrolytic cell is in the range of about 20 V to about 30 V, for example about 24.65 V±0.12 V. The input of electrical current can be further be through a 110 V (60 Hz) or 220 V, 50 Hz or 60 Hz circuit.

The reactor can be configured to perform the electrolytic reaction under reduced pressure or in a vacuum. Vacuum-electrolysis reactors are known in the art and suitable apparatuses will be readily apparent to a person of ordinary skill. The electrolysis reaction can be conducted at standard temperature and pressure (STP). In some embodiments, the reaction is initially conducted at STP, then subsequently, once the production of reducing gas begins inside the reactor chamber, the pressure can be reduced inside the reaction chamber. For example, the reduced pressure can be about 0.3 bar to about 0.9 bar. In some embodiments, the reduced pressure is 0.5±0.05 bar. By performing the reaction under reduced pressure, the rate of production of the reducing gas can be increased by up to 2.2 fold over the reaction performed at standard atmospheric pressure.

In some embodiments, the liquid can be an aqueous solution having medium to high biochemical oxygen demand (BOD). BOD is defined as the amount of dissolved oxygen needed by aerobic biological organisms to break down organic material present in a given water sample, most commonly expressed in milligrams of oxygen consumed per liter of sample during 5 days of incubation at 20° C. In some embodiments, the aqueous solution has a 5-day BOD in the range of about 2 mg/F to about 600 mg/F.

Infusion can be conducted by any suitable method. For example, the gas can be infused into the liquid by bubbling the reducing gas into the liquid. The bubbling can be conducted simultaneously with electrolytic production of the reducing gas by coupling the reactor to a container having the liquid therein and flowing the reducing gas into the liquid as it is produced. Alternatively, the infusion can be conducted by bubbling a stored reducing gas, such as in a pressurized gas tank, into a container having the liquid therein.

The infusion process can be augmented by adding the reducing gas to the liquid under turbulent conditions. In fluid dynamics, turbulence or turbulent flow is any pattern of fluid motion characterized by chaotic changes in pressure and flow velocity. Turbulence is caused by excessive kinetic energy in parts of a fluid flow, which overcomes the damping effect of the fluid's viscosity. In general terms, in turbulent flow, unsteady vortices appear of many sizes which interact with each other. Turbulent conditions can be created by a variety of methods that are well-known, which include, but are not limited to, vortexing, shaking, vibrating, mixing, flotation, and cavitation. Turbulence and cavitation improve dissolution rate of the reducing gas into the liquid by up to 100-fold, depending on the application and on the flow capacity of the recirculating pump, typically measured in volume units (e.g. gallons, liters) per minute. In some embodiments, the turbulent conditions are produced by cavitation, wherein the cavitation is conducted using a propeller, impeller, or suitable device. In one example, a recirculating pump is used that contains an impeller, at a rate of up to 3600 revolutions per minute (RPM), preferably 750-900 RPM. Venturi technology is also used when the turbulence is created inside pipes that have a positive flow pressure of liquids.

In producing the stable reducing liquid, the reducing gas is infused into the liquid until a threshold negative ORP is achieved and observed for a sufficient amount of time (stabilization or retention time) to reliably measure the ORP value using a commercially available and calibrated ORP meter with a waterproof electrode, preferably one that can also measure pH. A person of ordinary skill in the art will understand the routine conventions associated with the measurement of reduction potentials, including standard oxidation reduction potentials. This stabilization time will vary depending on the amount of liquid produced per unit of time. In some embodiments, the stabilization time is at least about 2 minutes. In other embodiments, the stabilization time is at least about 10 minutes. More generally, the stabilization time will vary from a few seconds to 28 hours, depending on several factors including the degree of chemical oxygen demand (COD) and the presence or absence of colloidal particulates, oils, solvents and/or others dissolved solutions. Reduced pressure and turbulence will improve the efficiency and thus will reduce the retention time by up to a factor of 100. Appropriate methods for the determination of the appropriate stabilization time for a liquid sample of interest are within the technical knowhow of a person of ordinary skill in the art. The induction of reduced pressure and turbulence will also allow the generation of a “residual effect” in many cases. For example, by applying the correct stabilization time, the infused liquid will maintain a reducing and disinfecting residual effect (i.e. replacing oxidants like chlorine, ozone, UV, H2O2, etc). In some embodiments, the threshold ORP after stabilization is −150 mV or more negative.

A composite reducing liquid comprising a nontoxic, non-corrosive reducing agent and the infused reducing liquid described herein can also be prepared. The nontoxic, non-corrosive reducing agent can be any compound that is readily miscible with the infused reducing liquid. Suitable reducing agents include, but are not limited to, natural antioxidants for example, ascorbic acid (vitamin c), glutathione, melatonin, and water-soluble tocopherols (vitamin E). In some embodiments, the non-toxic, non-corrosive reducing agent is an alkaline cationic silicate as described herein. The composite reducing liquid can be produced by any suitable method. In some embodiments, the non-toxic, non-corrosive reducing agent is added in a predetermined quantity to an infused reducing liquid. In other embodiments, the reducing agent and the reducing gas are simultaneously infused into a liquid. This simultaneous infusion can be conducted under turbulent conditions, such as using a recirculating pump at a rate of at least about 800±35 RPM.

The addition can be conducted by quantitative transfer of a single aliquot into the infused reducing liquid. Alternatively, the addition can be conducted by a continuous transfer of the reducing agent from a storage vessel at any desired flow rate over a specific period of time. The flow rate(s) and time will depend on the reducing agent and the desired stoichiometric ratio of reducing agent to infused reducing liquid in the composite reducing liquid. In another embodiment, the reducing agent is added in a punctuated, drop-wise fashion comprising multiple aliquots.

In some embodiments of the process for producing an aqueous reducing liquid, the infusion step of reducing gas, previously described, is performed by infusing 75 to 120 liters per minute of reducing gas per every 60 gallons per minute of the liquid to be restructured, prior to or simultaneously with the alkaline cationic silicate in the range of 0.5 to 12 milligrams per liter. In other embodiments, the quantity of the alkaline cationic silicate required in the process step is in amounts described herein-above, wherein the alkaline cationic silicate comprising of lithium silicate, sodium silicate, potassium silicate, ammonium silicate, or a combination thereof.

In one aspect, the process for preparing a reducing liquid comprising infusing a reducing gas (e.g. a reducing gas produced by an electrolytic process described herein) into a quantity of liquid under turbulent conditions. Inducing turbulence and cavitation in this process increases the efficiency of restructuring the water in the tank up to a thousand fold. It allows for the use of 1 kw of power per every ten thousand (10,000) gallons of water to be restructured per hour. Without the implementation of the cavitation/turbulence system, the rate of dissolution of gas with liquid is inefficient for utility. However, the upper limit for turbulent conditions in this process is less than 3600 RPM because excessive turbulence leads potential cavitation of the impeller of the water pump, which is undesirable for utility.

In some embodiments, the restructuring process comprises the following steps: reducing water gas (“C1”) and reducing liquid metasilicate (“C2”) are injected immediately before the source liquid enters into any conventional reservoir or container. The source liquid to be treated may go through (i) a closed pressured pipe; or (ii) an open water tank, channel, or open pipe under atmospheric conditions or normal temperature and pressure conditions.

If the source liquid to be treated goes through a closed pressurized pipe, the following steps are further performed: (i) C1 and C2 are injected to the pipe, where C1 is injected via a Venturi apparatus or via another method of creating negative pressure in the pipe; (ii) C2 is proportionally injected via conventional dosing pumps, gravitational dosing methods, or any other method used to dosify liquid chemicals. Negative pressure improves the production of the liquid. Depending on the electrolytic cell, the improvement of gas production can be up to 250%. Different tests conducted show with accuracy that it takes about 9325 liters of C1 gas under NPT conditions to restructure, in about 10 hours. 5000 gallons of water to be treated. This value is equivalent to 932.5 liters of C1 per hour without using enhancing methods of cavitation. The flow of reducing gas (C1) is then measured as flow in liters per hour (FLPH) using a formula that varies depending on the source liquid and other parameters, described further herein for each source liquid and corresponding use. Once the closed pressurized system is stabilized, The ORP value is measured in millivolts (mv). The ORP will vary depending on the composition of the source liquid. The minimum contact time of C1 with the source liquid required inside the pipe is typically between 3 seconds and 30 minutes. The ORP charge is measured after at least 3 seconds of minimum contact time of C1 with the source liquid and should result in a negative value. The formula for calculating FLPH is irrelevant of the liquid pressure inside the pressurized pipe. The volume (milliliters) of liquid metasilicate (C2) required to restructure a source liquid (C2) is determined using a formula described herein-below, which varies based on the composition of the source liquid and its desired use.

If the liquid to be treated goes through atmospheric pressure (open tank, channel or open pipe) or under normal temperature or pressure conditions, then following steps apply for mixing C1 and C2: (i) C1 is mixed with source liquid via under turbulent conditions or via cavitation induced by using flotation modes, recirculating pumps creating vacuum and/or a Venturi apparatus; (ii) C2 is mixed with the source liquid via existing conventional dosing pumps, gravitation dosifiers, or analogous methods apparent to a person with ordinary skill in the art. The FLPH of C1 is in then measured in liters per hour using a formula specific that varies based on the composition of the source liquid and process conditions, described further herein-below which varies based on the composition of the source liquid, process conditions, and the desired use for the source liquid. The volume (milliliters) of liquid metasilicate required to restructure water (C2) is determined using a formula described herein-below, which also varies based on the composition of the source liquid, process conditions, and the desired use for the source liquid. The minimum contact of C2 in the source liquid reservoir or container is typically between 15-30 minutes to achieve a negative ORP. If the residual negative ORP value (mv) is less than −200 mV, then contact time is extended until the ORP is more negative than −200 mV.

One aspect and specific application of the restructuring process is to prepare potable or “ready to drink” (RTD) water or other beverages for human and nonhuman (animals) consumption. The restructuring process described herein-above can be applied to any water based product suitable for human and nonhuman consumption including but not limited to drinking water, carbonated beverages, juices, colored beverages, organic beverages, teas, coffees, energy drinks, CBD beverages containing cannabinoid oil, and any other beverage with added organic and/or inorganic chemical components. Wherein, the reduced drinking water is (1) substantially free of alkaline chemicals, such as but not limited to, sodium or potassium hydroxide or sodium bicarbonate; and (2) substantially free of oxidants, such as but not limited to, calcium hypochlorite, sodium hypochlorite, gaseous chlorine, bromine, iodine, ozone, or ultraviolet light. An additional benefit of the reducing or restructuring process is that the original color, taste, and odor of the reducing drinking water is preserved. Substantially free refers to oxidant quantities less than about 1%, preferably less than about 0.1% for the indicated matter.

Under normal conditions of preservation and handling, the hydration (surface tension) and alkalinity (pH) stay stable for at least 12 months after the restructuring process. Stability studies were conducted adding 1.Omg/liter of SSC to (i) a 55 gallon drum made of BPA plastic human grade (with zero UV penetration); (ii) 1 L metallic bottles; (iii) 1 L glass bottles; (iv) 1 L plastic bottles. The reducing gas was infused into each container with a contact time of 30 minutes. Post stabilization, the pH was measured to be around 10. The drum and bottles were scaled was then kept outside under atmospheric conditions for two years in Florida, USA. After two years, the pH of the water bottle was still around 10, without any microbial growth.

The stability of the liquid water is increased because the reducing water is substantially free of oxidants because they are effectively neutralized via the reduction process, particularly oxidants such as of calcium hypochlorite, sodium hypochlorite, gaseous chlorine, bromine, iodine, ozone, and/or ultra violet light. The thus restructured water may then be used to prepare a cell culture medium of the present invention.

In some embodiments, the reducing liquid is restructured water or a restructured aqueous solution.

In some embodiments, the reducing liquid obtained has a pH of about 7, or 7-14, or 7-13, or 7-12, or 7-11, or 7-10, or 7-9, or 7-8, or 8-14, or 8-13, or 8-12, or 8-11, or 8-10, or 8-9, or 9-14, or 9-13, or 9-12, or 9-11, or 9-10, or 10-14, or 10-13, or 10-12, or 10-11, or 11-14, or 11-13, or 11-12, or 12-14, or 12-13, or 13-14.

In other embodiments, the obtained reducing liquid has a pH of at least about 7.0. In certain other embodiments, the obtained reducing liquid has a pH of at least about 9.5.

In certain embodiments, the obtained reducing liquid has a pH of at least about 13.0.

Further, after undergoing the restructuring process, despite an alkaline pH of over 9.5 measured as equivalent oxidation reduction potential (ORP) greater than (−300 mv), the resulting solution is nonetheless non-caustic, and non-toxic to mammals (e.g., humans and animals such as pets) upon contact or ingestion, including an even highly alkaline pH of over 13.0 with ORP value greater than (−550 mv).

The addition/infusion of the liquid metasilicate is not chemically induced, nor produced by alkaline chemicals (such as sodium hydroxide, sodium bicarbonate, etc).

In an aspect, the restructuring described herein lowers the ORP value of a liquid.

In some embodiments, the restructuring converts the ORP from a positive to a negative value. Decreasing the ORP charge to a negative value is desirable because it alleviates the oxidative stress of a system, which is known in the art to be harmful to a particular system.

In other embodiments, a composition of the present invention has an ORP value of −50 mV or more negative, or −100 mV or more negative, or −200 mV or more negative, or −300 mV or more negative, or −400 mV or more negative, or about −50 mV to about −800 mV, or about −400 mV to about −600 mV, preferably about −300 mV to about −500 mV, more preferably about −200 mV to about −400 mV. In some embodiments, the composition has an ORP value of −800 mV or even more negative.

Further, compared to the non-restructured form of the same liquid, the restructured form of the liquid will exhibit additional properties, for example, a pH greater than 7, decreased surface tension, improved hydration, improved bio-assimilation, improved solubility of organic or inorganic compounds with the liquid, and antimicrobial properties. Accordingly, preparations of food products using restructured liquid confers antimicrobial (e.g., antibacterial) character to a food product, thereby improving shelf-life and stability and reducing or preventing bacterial growth and contamination.

The present inventors have found that the electrolytic process described herein releases free electrical charge via the water-based reducing gas and the liquid metasilicate and its reducing, high alkaline, non-caustic, and nontoxic properties.

The antimicrobial (e.g., disinfecting) and bactericidal properties inherent to reducing restructured water or aqueous solution enhances the storage and shelf life of compositions prepared therewith, making the restructured water or restructured aqueous solution particularly suited as a preservative composition or for use in preparing a preservative composition which imparts antibacterial properties or activity to a food product. Compositions (e.g., preservative compositions) prepared by the electrolytic process described herein are useful for preparing formulations intended for consumption as food by a mammal such as a pet or a human, or by poultry, a fish, a reptile or other animal species. In certain embodiments, the composition is a pet food containing a preservative composition prepared according to a method described herein.

In an aspect, a food product as described herein may be a dry pet food, a wet pet food (e.g., a canned pet food), a treat, a probiotic supplement, a vitamin, or other composition or preparation intended for oral ingestion by a mammal.

In certain embodiments, the food product or composition is prepared by a method involving mixing the preservative composition (e.g., a restructured liquid composition) with other ingredients to form a pet food composition.

In other embodiments, the food product or composition of the present invention is prepared by admixing an already-prepared food product or composition with the preservative composition (e.g., a restructured liquid composition).

In certain embodiments, the preservative, antioxidant composition is added by mixing with the food product or composition (i.e., before being bottled, canned or stored in any other container, such as aplastic bag, sealed plastic or metallic container, etc.). The percentages in volume of the preservative and antioxidant composition depend on the amount of organic matter and its chemical and biochemical properties at the moment of being packed (e.g., acidity (pH), COD (chemical oxygen demand in mg/lt). BOD5 (biochemical oxygen demand after 5 days, measured in mg/lt), ORP (oxidation reduction potential measured in mv), nitrates, nitrites, ammonia, sulfurs, percentage of humidity, oxidation stability, etc.

In certain embodiments, a food product or composition described herein comprises the preservative composition in an amount of at least 0.0005% by weight of the food product.

In certain embodiments, a food product or composition described herein comprises the preservative composition in an amount of at least 0.005% by weight of the food product.

In certain embodiments, a food product or composition described herein comprises the preservative composition in an amount of about 0.0005% to about 5% by weight of the food product.

In certain embodiments, a food product or composition described herein comprises the preservative composition in an amount of about 0.001% to about 1% by weight of the food product.

In certain embodiments, a food product or composition described herein comprises the preservative composition in an amount of about 0.002% to about 0.75% by weight of the food product.

In certain embodiments, a food product or composition described herein comprises the preservative composition in an amount of about 0.005% to about 0.5% by weight of the food product.

In an aspect, one or more ingredients of a pet food composition may be combined with a preservative composition described herein and subsequently blended, pureed, compressed into dry pellets or tablets, or otherwise mixed or combined to form a stable pet food product.

In another aspect, a liquid food product or drink intended for consumption by pets (e.g., mammals) is provided. In an embodiment, a restructured liquid is provided to a pet for consumption. In another embodiment, a restructured liquid is mixed with one or more other liquids to prepare a liquid food product or drink for pet consumption.

In another aspect, additive compositions are provided by the present disclosure. An additive composition described herein may be prepared using the electrolytic process described herein (Hydrogas™). The additive may be liquid, solid, or semi-liquid (e.g., a gel). The additive may be prepared via a method described herein, e.g., by preparing an aqueous restructured liquid. The additive may comprise one or more flavorants, palatants, stabilizers, emulsifiers, or other food-grade or food-safe ingredients or components.

In an aspect, an additive described herein may be mixed with a food product during preparation (i.e., manufacture) of the food product. Alternatively, the additive may be added to a food product or composition following manufacture (e.g., by a pet owner prior to feeding a pet).

### EXAMPLES

### Example 1: Pet Food Preservative Compositions

This example describes trials to assess the safety and efficacy of the compositions described herein in preserving pet food compositions. In the following Examples, various formulations of a preservative composition were prepared at different concentrations.

In each case, the active compound and active silica were prepared by Hydrogassing wet dog food samples (i.e., infusing samples with Hydrogas as described herein), followed by adding reformed sodium metasilicate (RLS) in the specified concentrations set forth below (i.e., 0.002% to 0.10%).

Four commercially available canned (i.e., wet) dog food products were used in the following experiments. For each dog food, four cans were used (three for testing and one for control):

The dog foods used were (1) Purina® Dog Chow® High Protein in gravy; (2) Blue Buffalo® Wilderness High Protein Food for Dogs (Chicken & Salmon); (3) Pedigree® Chopped Ground Dinner (chicken); and (4) Cesar® Wet Dog Food Loaf & Topper in Sauce.

In all cases the control sample shows pH values around 4.5 and the treated samples show pH values above 8.0. The dogs preferentially accepted treated samples over non-treated (control) samples. Cans of treated food were left open for five days. Control cans oxidized after approximately eight hours, while the treated cans did not oxidize after the five days and were eaten by the subject dogs normally.

In particular, the pet food compositions were assessed for stability and presence of certain microbes, namely Staphylococcus aureus, Pseudomonas aeruginosa, Salmonella, Escherichia (E. coli), and total coliform bacteria. Microbiological assessments were conducted according to protocols USP61 and USP62. Detailed explanations on how these tests are conducted can be found, for example at the official USP.org website: (www.usp.org/sites/default/files/usp/document/harmonization/gen-method/q05a_pf_ira_34_6_2008.pdf).

No clumping or discoloration was observed in any of the preservative compositions prepared according to the following Examples.

Additionally, no unpleasant or foul odors were present in any of the preservative compositions of the Examples.

The preservative compositions of the Examples were analyzed for uniformity using transmission electron microscopy and wavelength matrix analysis. Each of the preservative compositions of the Examples exhibited uniformity as desired.

Furthermore, a stability study indicated that the preservative compositions of the following Examples exhibited both microbial and chemical stability during a 14-day Antimicrobial Effectiveness Test (AET) as well as accelerated stability assessment at 40° C.

### [A] Experiment A:

Four (4) pet food preservative compositions were assessed after fourteen (14) days. The four compositions had the following concentrations of active compound (based on weight of the pet food composition):
Composition 1.1:0.01% active
Composition 1.2:0.0075% active
Composition 1.3:0.005% active
Composition 1.4:0.002% active

The compositions were observed to be beige (e.g., light brown, off-white, tan) in color and soft in texture. No discoloration or clumping was observed, nor was any unpleasant or foul odor detected.

The four compositions were assessed for presence of microbiological contamination of the above-noted contaminants. <1000 colony-forming units per gram (CFU/g) of yeast or mold were measured in the four compositions. Additionally, <1000 CFU/g total plate count was measured for all four compositions.

Additionally, Pseudomonas aeruginosa, Salmonella and Escherichia were absent in all four compositions.

Staphylococcus aureus was absent in Composition 1.1, but was present in Compositions 1.2, 1.3 and 1.4.

Total coliform was present in Compositions 1.3 and 1.4.

Transmission electron microscopy and wavelength analysis confirmed uniformity (i.e., matrix homogeneity).

### [B] Experiment B

In this Example, four (4) pet food preservative compositions were assessed after fourteen (14) days. The four compositions had the following concentrations of active compound (based on weight of the pet food composition):
Composition 2.1:0.01% active
Composition 2.2:0.02% active
Composition 2.3:0.03% active
Composition 2.4:0.10% active

The compositions were observed to be beige (e.g., light brown, off-white, tan) in color and soft in texture. No discoloration or clumping was observed, nor was any unpleasant or foul odor detected.

The four compositions were assessed for presence of microbiological contamination of the above-noted contaminants. <1000 colony-forming units per gram (CFU/g) of yeast or mold were measured in the four compositions. Additionally, <1000 CFU/g total plate count was measured for all four compositions.

Additionally, Pseudomonas aeruginosa, Salmonella, Escherichia, Staphylococcus aureus, and total coliform were all absent in all four compositions.

Transmission electron microscopy and wavelength analysis confirmed uniformity (i.e., matrix homogeneity).

### [C] Experiment C:

In this Example, four (4) pet food preservative compositions were assessed after fourteen (14) days. The four compositions had the following concentrations of active compound (based on weight of the pet food composition):
Composition 3.1:0.01% active silica
Composition 3.2:0.02% active silica
Composition 3.3:0.03% active silica
Composition 3.4:0.10% silica

The compositions were observed to be beige (e.g., light brown, off-white, tan) in color and soft in texture. No discoloration or clumping was observed, nor was any unpleasant or foul odor detected.

The four compositions were assessed for presence of microbiological contamination of the above-noted contaminants. <1000 colony-forming units per gram (CFU/g) of yeast or mold were measured in the four compositions. Additionally, <1000 CFU/g total plate count was measured for all four compositions.

Additionally, Pseudomonas aeruginosa, Salmonella, Escherichia, Staphylococcus aureus, and total coliform were all absent in all four compositions.

Transmission electron microscopy and wavelength analysis confirmed uniformity (i.e., matrix homogeneity).

### [D] Experiment D:

In this Example, four (4) pet food preservative compositions were assessed after fourteen (14) days. The four compositions had the following concentrations of active compound (based on weight of the pet food composition):
Composition 4.1:0.01% active silica
Composition 4.2:0.0075% active silica
Composition 4.3:0.005% active silica
Composition 4.4:0.002% silica

The compositions were observed to be beige (e.g., light brown, off-white, tan) in color and soft in texture. No discoloration or clumping was observed, nor was any unpleasant or foul odor detected.

The four compositions were assessed for presence of microbiological contamination of the above-noted contaminants. <1000 colony-forming units per gram (CFU/g) of yeast or mold were measured in the four compositions. Additionally, <1000 CFU/g total plate count was measured for all four compositions.

Additionally, Pseudomonas aeruginosa, Salmonella and Escherichia were absent in all four compositions.

Staphylococcus aureus was absent in Compositions 4.1 and 4.2, but was present in Compositions 4.3 and 4.4.

Total coliform was absent in Compositions 4.1 and 4.2, but was present in Compositions 4.3 and 4.4.

Transmission electron microscopy and wavelength analysis confirmed uniformity (i.e., matrix homogeneity).

### REFERENCES

1. Guideline for Industry, Q2B Validation of Analytical Procedures: Methodology, International Committee for Harmonization, 1996.
2. Reviewer Guidance, Validation of Chromatographic Methods, Center for Drug Evaluation and Research (CDER), 1994.

1. A method for preparing a preservative and antioxidant food composition, the method comprising:
(i) infusing an aqueous solution with a reducing gas and a metasilicate, wherein the infusing involves mixing under turbulent conditions, to produce a preservative composition, and
(ii) admixing the preservative composition with a food composition to produce a preservative food composition;
wherein the reducing gas and/or the metasilicate reacts with the aqueous solution to produce a reducing liquid having the oxidation reduction potential (ORP) value of about −100 mV or more negative.

2. A method for preparing a preservative and antioxidant food composition, the method comprising:
infusing a food composition with a reducing gas and a metasilicate, wherein the infusing involves mixing under turbulent conditions, to produce a preservative food composition;
wherein the reducing gas and/or the metasilicate reacts with the aqueous solution to produce a reducing liquid having the oxidation reduction potential (ORP) value of about −100 mV or more negative.

3. The method of claim 1, wherein the reducing gas and/or the metasilicate reacts with the aqueous solution to produce a reducing liquid having the oxidation reduction potential (ORP) value of about −500 mV or more negative.

4. The method of claim 3, wherein the mixing occurs at a flow rate of 100-500 liters of reducing gas per hour under turbulent conditions, for at least five minutes.

5. The method of claim 3, wherein the mixing occurs at a flow rate of 25-75 liters of reducing gas per hour under turbulent conditions for at least five minutes.

6. The method of claim 1, wherein the preservative composition is present in the preservative food composition in an amount of at least 0.0005% by weight of the preservative food composition.

7. The method of claim 1, wherein the preservative composition is present in the preservative food composition in an amount of at least 0.005% by weight of the preservative food composition.

8. The method of claim 1, wherein the preservative composition is present in the preservative food composition in an amount of about 0.0005% to about 5% by weight of the food product.

9. The method of claim 1, wherein the preservative composition is present in the preservative food composition in an amount of about 0.001% to about 1% by weight of the preservative food composition.

10. The method of claim 1, wherein the preservative composition is present in the preservative food composition in an amount of about 0.002% to about 0.75% by weight of the preservative food composition.

11. The method of claim 1, wherein the preservative composition is present in the preservative food composition in an amount of about 0.005% to about 0.5% by weight of the preservative food composition.

12. The method of claim 1, wherein the preservative composition comprises reformed silica.

13. The method of claim 12, wherein the silica is reformed liquid sodium metasilicate having a negative ORP of about −250 mv to about −400 mv) and a pH of around 12.7 to 13.7.

14. The method of claim 1, wherein the metasilicate is a sodium silicate complex with a pH of 13.7.

15. A preservative food composition, which is prepared by a method of claim 1.

16. The preservative food composition of claim 15, which is a pet food.

17. The composition of claim 15, wherein the reducing liquid has an oxidation reduction potential (ORP) value of about −500 mV or more negative.

18. The food composition of claim 14, wherein after a fourteen-day antimicrobial effectiveness test the food composition is free of Escherichia coli.

19. The food composition of claim 14, wherein after a fourteen-day antimicrobial effectiveness test the food composition is free of Salmonella.

20. The food composition of claim 14, wherein after a fourteen-day antimicrobial effectiveness test the food composition is free of Pseudomonas aeruginosa.
